(19) United States
(12) Patent Application Publication
(10) Pub. No.: US 2011/0033293 A1
(43) Pub. Date: Feb. 10, 2011

(54) Retractable Wind Turbine

(76) Inventor: Lincoln Joseph Cavalieri, Northville, MI (US)

Correspondence Address: JELIC PATENT SERVICES, LLC, 2922 MARSHALL ST, ANN ARBOR, MI, 48108, US

(21) Appl. No.: 12/538,225

(22) Filed: Aug. 10, 2009

(51) Int. Cl. F03D 1/00; F03D 11/00

(52) U.S. Cl. 416/9

(57) ABSTRACT

The disclosure provides a retractable wind turbine apparatus for generating power. When required, the mast and blades of the retractable wind turbine apparatus are designed to retract and become non-visible to an observer. The retractable wind turbine apparatus will enable power generation in locations where aesthetic issues are of a concern. Power generation may be stopped during designated periods such as tourist season or daylight hours. In these situations, the wind turbine apparatus will be retracted and hidden from view.

### BACKGROUND OF THE INVENTION

Currently, there is a growing demand for wind energy. In the past, this demand has been met using wind turbines for power generation.

### BRIEF SUMMARY OF THE INVENTION

The disclosure provides a retractable wind turbine apparatus for generating power. When required, the mast and blades of the retractable wind turbine apparatus are designed to retract and become non-visible to an observer. The retractable wind turbine apparatus will enable power generation in locations where aesthetic issues are a concern. Power generation may be stopped during designated periods such as tourist season or daylight hours. In these situations, the wind turbine apparatus will be retracted and hidden from view.

The apparatus will use a plurality of blades. One blade is independent. The other blades are either locked in their power generating position or their retracted position. When in power generating position, all of the blade tips are equidistant from each other. When in the retracted position, the blades are lined-up with the independent blade. In a separate embodiment, the plurality of blades may be may be permanently locked in their power generating position.

Different embodiments are available to retract the mast of the retractable wind turbine apparatus. A scissor lift embodiment may be used. A second embodiment is a solid mast which may be moved up or down via a gear system. A third embodiment uses a telescoping mast which is actuated with a spring loaded cable system.

### BRIEF DESCRIPTION OF THE DRAWINGS

FIG. 1 shows three blades locked in their power generating position.

FIG. 2 shows a retractable wind turbine apparatus using a scissor lift mast.

FIG. 3 shows a retractable wind turbine apparatus using a solid mast with a gear system.

FIG. 4 shows a retractable wind turbine apparatus using a telescoping mast with a spring loaded cable system.

### DETAILED DESCRIPTION OF THE INVENTION

There is growing demand for wind power, power which is derived from wind energy. Wind power is typically generated using wind turbines. These wind turbines can be large and in many cases are considered aesthetically unappealing. Wind farms, collections of wind turbines, have been stopped from construction due to public outcry over potential loss in property values. It is assumed that the property values of areas near the potential wind farms would drop due to the perception that wind turbines are aesthetically unappealing.

The present disclosure provides a retractable wind turbine apparatus for generating power. The retractable wind turbine apparatus may be retracted and hidden from view during periods of concern when aesthetics are important. Examples of such periods are daytime hours or a tourist season. The retractable wind turbine apparatus may then be placed back into service at times when aesthetics are less important.

In developing the present disclosure, the inventors have found unexpected results. One unexpected result is that there is an added benefit of being able to retract the wind turbine apparatus and protect it during difficult weather conditions. A second unexpected result is the potential reduction in maintenance costs derived from protecting the retractable wind turbine apparatus during during difficult weather conditions.

The present apparatus is comprised of blades, a mast, and means to retract the blades and mast.

The apparatus will use a plurality of blades. One blade is independent. The other blades are either locked in their power generating position or their retracted position. When in power generating position, all of the blade tips are equidistant from each other. When in the retracted position, the blades are lined-up with the independent blade. In a separate embodiment, the plurality of blades may be may be permanently locked in their power generating position.

Different embodiments are possible for the mast. A first embodiment is to use a scissor lift for the mast. A second embodiment is to use a single section mast. The single section mast may have teeth on the side(s) to enable motion via a gear system. A third embodiment uses a telescoping mast. The telescoping mast uses an spring-loaded cable or other device capable of providing necessary tension.

Different means may be employed to retract the blades and mast. The means employed correspond to the type of mast used. When using a scissor lift mast, a motor may be used to provide the necessary power to open and close the scissors. Opening the scissors lowers the mast, while closing the scissors raises the mast. When using a single section mast, a gear system may be used to raise or lower the mast. When using a telescoping mast, a spring loaded cable system may be used to raise or lower the mast.

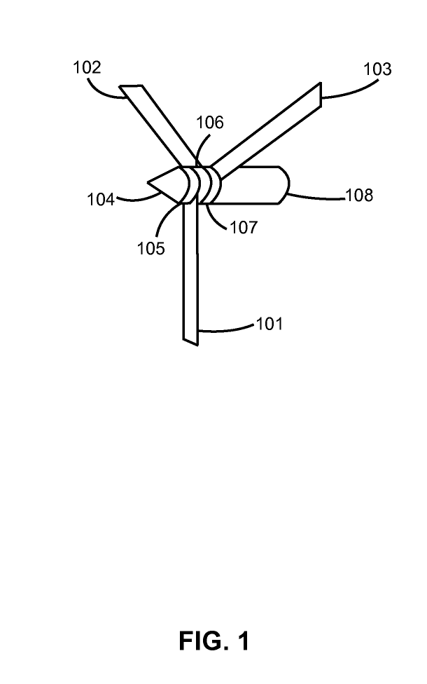

FIG. 1 shows a blade assembly locked in its power generating position. The independent blade 101 is permanently locked in position. The dependent blades 102 and 103 may be moved relative to the independent blade 101. A blade assembly fastener 104 ties the blade assembly to the generator drive shaft 108. Independent blade controller 105 positions the independent blade in a downward position when the blades are stopped.

Dependent blade actuator 106 positions corresponding blade 102 into either the power generating position, as shown, or the storage position. When moving from the power generating to storage position, blade 102 moves in a counter-clockwise motion. Conversely when moving from the storage position to power generating position, blade 102 moves in a clockwise motion.

Dependent blade actuator 107 positions corresponding blade 103 into either the power generating position, as shown, or the storage position. When moving from the power generating to storage position, blade 103 moves in a clockwise motion. Conversely when moving from the storage position to power generating position, blade 103 moves in a counter-clockwise motion.

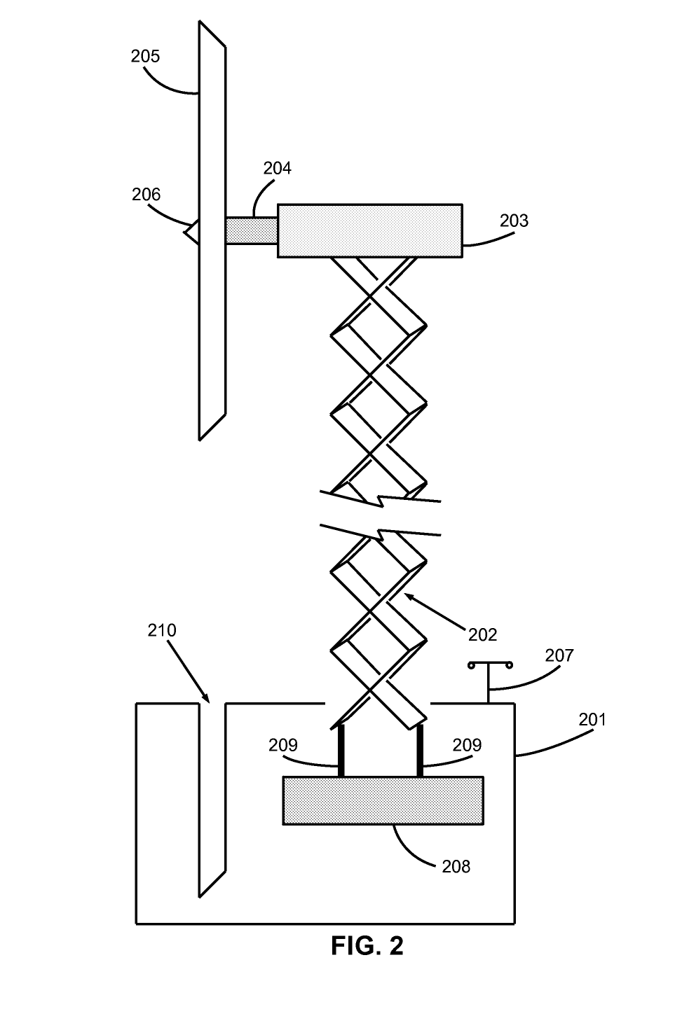

FIG. 2 shows a retractable wind turbine apparatus using a scissor lift mast 202. Wind energy is used to drive a blade assembly 205. A blade assembly fastener 206 ties the blade assembly 205 to a generator drive shaft 204. The generator drive shaft 204 drives a generator 203. The generator may be raised or lowered with the scissor lift mast 202. The scissor lift mast 202 may be raised or lowered with movable arms 209. The movable arms 209 are actuated with a motor 208. When the wind turbine apparatus is lowered, the blade assembly rests in a blade resting space 210. The blade assembly shown is the embodiment where a plurality of blades are permanently locked in their power generating position. The lift housing 201 is used to store the retractable wind turbine apparatus. An anemometer 207 may be used to determine wind speed. Wind speed may be a criterion used to determine whether or not the wind turbine apparatus should be raised or lowered.

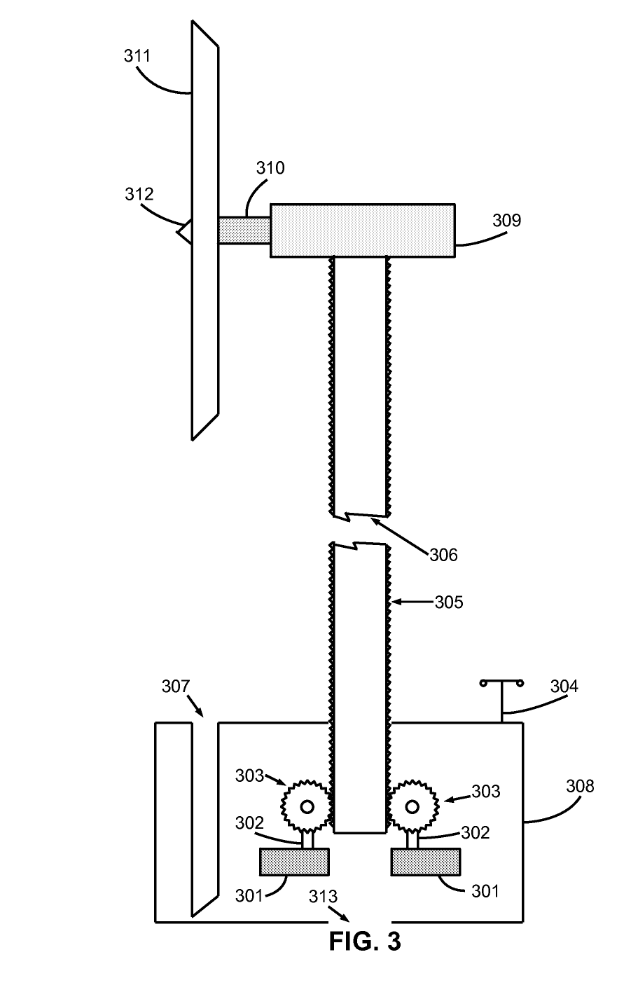

FIG. 3 shows a retractable wind turbine apparatus using a solid mast 306 with a gear system. Wind energy is used to drive a blade assembly 311. A blade assembly fastener 312 ties the blade assembly 311 to a generator drive shaft 310. The generator drive shaft 310 drives a generator 309. The generator may be raised or lowered with the solid mast 306. The solid mast 306 has teeth 305. The teeth 305 are used in conjunction with gears 303 to raise and lower the solid mast 306. The gears are driven with gear shafts 302. The gear shafts 302 are driven with motors 301. When the mast is lowered, it is stored in a mast resting place 313. When the wind turbine apparatus is lowered, the blade assembly rests in a blade resting space 307. The blade assembly shown is the embodiment where a plurality of blades are permanently locked in their power generating position. The lift housing 308 is used to store the retractable wind turbine apparatus. An anemometer 304 may be used to determine wind speed. Wind speed may be a criterion used to determine whether or not the wind turbine apparatus should be raised or lowered.

In a separate embodiment, a hydraulic system may be substituted for the gear system shown in FIG. 3. The hydraulic system is capable of raising and lowering the mast.

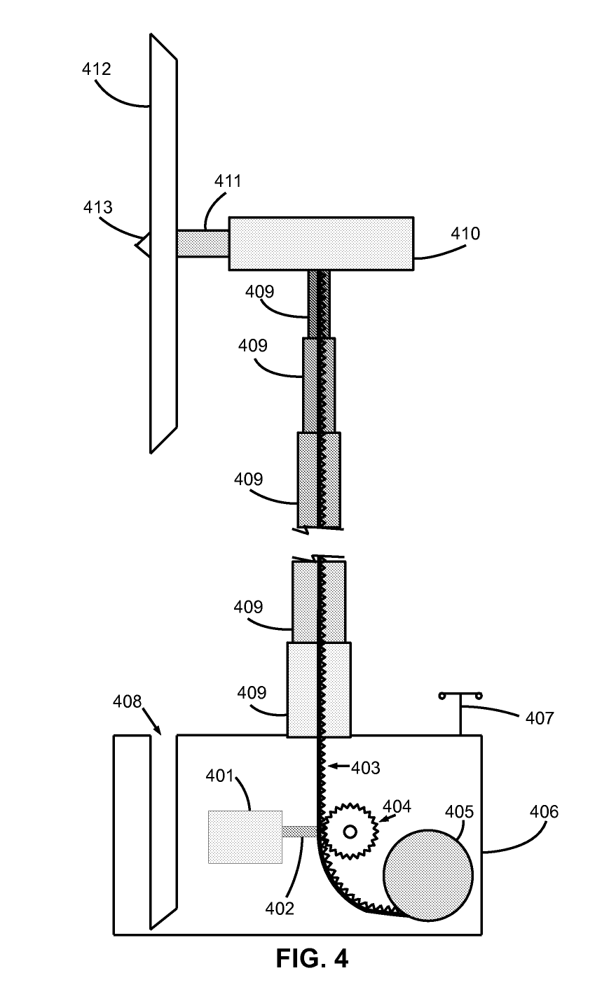

FIG. 4 shows a retractable wind turbine apparatus using a telescoping mast 409 with a spring loaded cable system. Wind energy is used to drive a blade assembly 412. A blade assembly fastener 413 ties the blade assembly 412 to a generator drive shaft 411. The generator drive shaft 411 drives a generator 410. The generator may be raised or lowered with the telescoping mast 409. The telescoping mast 409 has an internal spring loaded cable with teeth 403. The spring loaded cable with teeth 403 is used in conjunction with a gear 404 to raise and lower the telescoping mast 409. Cable brackets and a channel guide are used to support the spring loaded cable with teeth 403. The gear is driven with a gear shaft 402. The gear shaft 402 is driven with a motors 401. When the wind turbine apparatus is lowered, the blade assembly rests in a blade resting space 408. The blade assembly shown is the embodiment where a plurality of blades are permanently locked in their power generating position. When the wind turbine apparatus is lowered, the spring loaded cable with teeth is stored in a cable storage space 405. The lift housing 406 is used to store the retractable wind turbine apparatus. An anemometer 407 may be used to determine wind speed. Wind speed may be a criterion used to determine whether or not the wind turbine apparatus should be raised or lowered. While the disclosure describes embodiments and various alternatives thereto, it should be apparent that the invention is not limited to such embodiments. Rather, many variations would be apparent to persons of skill in the art without departing from the scope and spirit of the invention, as defined herein and in the claims.

The invention claimed is:

1. A retractable wind turbine apparatus comprising:
a blade assembly with a plurality of blades;
a retractable mast; and
means to retract the mast.

2. The apparatus of claim 1 wherein the retractable mast comprises a scissor lift mast and the means to retract the retractable mast comprises movable arms with a motor.

3. The apparatus of claim 1 wherein the retractable mast comprises a solid mast and the means to retract the retractable mast comprises a gear system.

4. The apparatus of claim 1 wherein the retractable mast comprises a telescoping mast and the means to retract the retractable mast comprises a spring loaded cable system.

5. The apparatus of claim 2 wherein the blade assembly with the plurality of blades comprises one independent blade and one or more dependent blades capable being moved relative to the independent blade.

6. The apparatus of claim 3 wherein the blade assembly with the plurality of blades comprises one independent blade and one or more dependent blades capable being moved relative to the independent blade.

7. The apparatus of claim 4 wherein the blade assembly with the plurality of blades comprises one independent blade and one or more dependent blades capable being moved relative to the independent blade.

8. The apparatus of claim 2 wherein the blade assembly with the plurality of blades comprises blades that are permanently locked in their power generating position.

9. The apparatus of claim 3 wherein the blade assembly with the plurality of blades comprises blades that are permanently locked in their power generating position.

10. The apparatus of claim 4 wherein the blade assembly with the plurality of blades comprises blades that are permanently locked in their power generating position.
